(19) United States
(12) Patent Application Publication
(10) Pub. No.: US 2014/0180910 A1
(43) Pub. Date: Jun. 26, 2014

(54) DORMANT SHIPPING LABEL

(71) Applicant: Srinivasan Raman, Cupertino, CA (US)

(72) Inventor: Srinivasan Raman, Cupertino, CA (US)

(73) Assignee: eBay Inc., San Jose, CA (US)

(21) Appl. No.: 13/725,889

(22) Filed: Dec. 21, 2012

(51) Int. Cl. G06Q 10/08

(52) U.S. Cl. CPC G06Q 10/083
USPC 705/39; 705/330

(57) ABSTRACT

A system and method for a dormant shipping label system are described. A shipper registers with the dormant shipping label system. Partial shipping information for a shipment is received from the shipper. The dormant shipping label system generates a dormant shipping label based on the partial shipping information and provides the dormant shipping label to the shipper, the dormant shipping label to be activated with a shipping service provider that generated the dormant shipment label upon receipt of additional shipping information to compute a shipping cost of the shipment, and upon receipt of payment of the shipping cost.

### TECHNICAL FIELD

This application relates generally to the field of computer technology and, in a specific example embodiment, a method and system for generating a dormant shipping label.

### BACKGROUND

Online marketplaces include many sellers listing items for sale. Buyers buy these items and sellers ship the items to the buyers upon receipt of payment. The shipping process typically includes the seller packing the item in a box, sealing it up, bring it to the post office, filling out the necessary forms, weighing the package to calculate the postage, paying for the postage, taping the stamp on the box, and finally dropping the box in the parcel deposit area. Because this inefficient shipping process entails many steps, it becomes a deterrent for sellers to list, sell, and ship their items.

### BRIEF DESCRIPTION OF THE DRAWINGS

The present disclosure is illustrated by way of example, and not by way of limitation, in the figures of the accompanying drawings in which:

FIG. 1 is a network diagram depicting a network system, according to one embodiment, having a client-server architecture configured for exchanging data over a network.

FIG. 2 shows a block diagram illustrating one example embodiment of a publishing application.

FIG. 3 shows a block diagram illustrating one example embodiment of a dormant shipping label application.

FIG. 4A shows a ladder diagram illustrating one example embodiment of a process for generating a dormant shipping label with shipping cost paid at the shipping service provider.

FIG. 4B shows a ladder diagram illustrating one example embodiment of a process for generating a dormant shipping label with shipping cost deducted from a shipper's account.

FIG. 4C shows a ladder diagram illustrating one example embodiment of a process for generating a dormant shipping label for use at a third party shipping service provider with shipping cost paid at a third party shipping service provider.

FIG. 4D shows a ladder diagram illustrating one example embodiment of a process for generating a dormant shipping label for use at a third party shipping service provider with shipping cost deducted from a shipper's account.

FIG. 5 shows a flow diagram illustrating one example embodiment of a method for generating a dormant shipping label.

FIG. 6 shows a diagrammatic representation of machine in the example form of a computer system within which a set of instructions may be executed to cause the machine to perform any one or more of the methodologies discussed herein.

### DETAILED DESCRIPTION

Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for a dormant shipping label system are described. A system and method for a dormant shipping label system are described. A shipper registers with the dormant shipping label system. Partial shipping information for a shipment is received from the shipper. The dormant shipping label system generates a dormant shipping label based on the partial shipping information and provides the dormant shipping label to the shipper to be activated with a shipping service provider.

### System Architecture

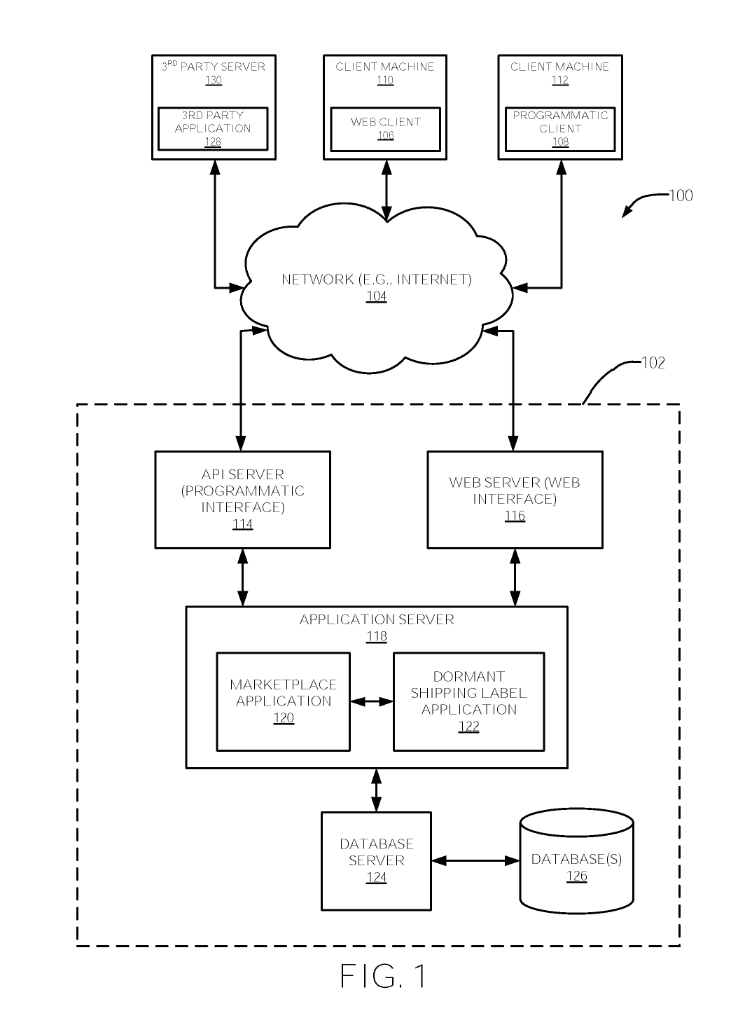

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as peer-to-peer or distributed network environments.

A data exchange platform, in an example form of a marketplace application 120 and a dormant shipping label application 122, may provide server-side functionality, via a network 104 (e.g., the Internet) to one or more clients. The one or more clients may include users that utilize the network system 100 and, more specifically, the marketplace application 120 and the dormant shipping label application 122, to exchange data over the network 104. These transactions may include transmitting, receiving (communicating), and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, with each in communication with the network-based publisher 102 and optionally each other. The buyers and sellers may be any one of individuals, merchants, or service providers.

Turning specifically to the marketplace application 120 and the dormant shipping label application 122, an application program interface (API) server 114 and a web server 116 are coupled to, and provide programmatic and web interfaces respectively to, one or more application servers 118. The application server 118 hosts one or more marketplace applications 120 and the dormant shipping label application 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or 3^{rd} party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the dormant shipping label application 122 includes a system and a method for generating and activating dormant shipping labels to a shipper or a seller of the marketplace application 120.

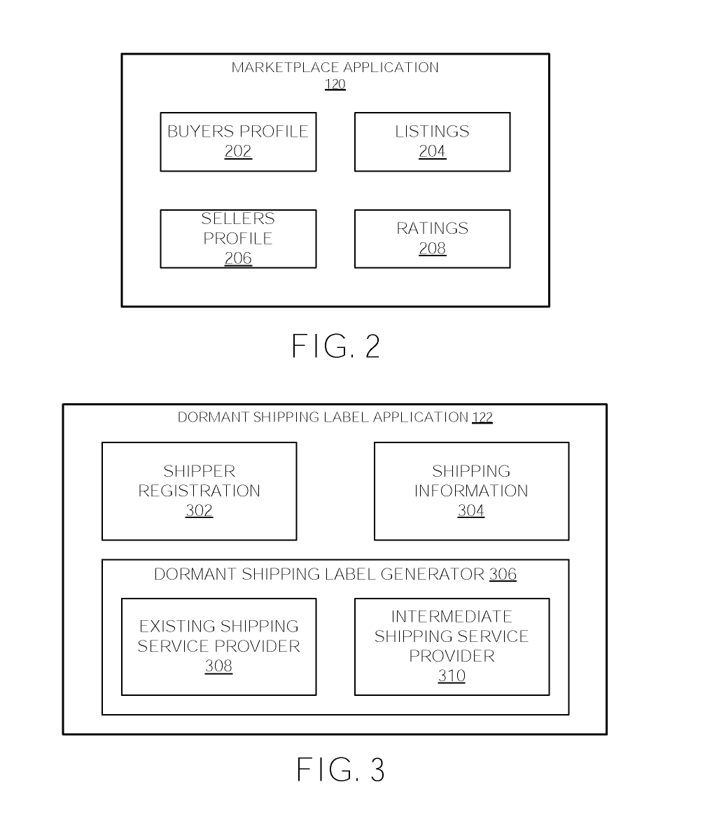

FIG. 2 shows a block diagram illustrating one example embodiment of the marketplace application 120. The marketplace application 120 includes, for example, a buyers profile module 202, a sellers profile module 206, a listings module 204, and a ratings module 208.

The buyers profile module 202 may be configured to generate and store profiles of buyers of the marketplace application 120. For example, the profiles of the buyers may include names, addresses (including shipping address), and transaction history.

The sellers profile module 204 may be configured to generate and store profiles of sellers of the marketplace application 120. For example, the profiles of the seller may include names, addresses (including shipping address), and transaction history.

The listings module 206 may be configured to generate and store listings from the sellers. The listings may identify items for sale in the marketplace application 120.

The ratings module 208 may be configured to generate and store ratings, including feedback ratings of buyers and sellers. In another embodiment, the ratings module 208 may also be configured to generate transaction volume and shipping volume on the marketplace application 120, or any other online marketplace.

FIG. 3 shows a block diagram illustrating one example embodiment of the dormant shipping label application 122. The dormant shipping label application 122 may include a shipper registration module 302, a shipping information module 304, and a dormant shipping label generator 306. The dormant shipping label generator 306 may include an existing shipping service provider module 308 and an intermediate shipping service provider module 310.

The shipper registration module 302 may register a shipper with the dormant shipping label system. For example, a shipper may sign up with the dormant shipping label system by providing basic information such as name, address, email address, and a credit card number.

The shipping information module receives partial shipping information for a shipment from the shipper. For example, the partial shipping information may include a destination address, a desired shipment service type (overnight, two-day delivery, first class, standard, bulk delivery, etc.), and the amount of insurance coverage, whether to have delivery confirmation, and so forth. The shipping information may also include information about the item being shipped. In one embodiment, the shipping information module 304 may communicate with the marketplace application 120 to determine the transaction on the online marketplace corresponding to the shipment. For example, the shipping information module 304 may extract information regarding the destination address and the desired shipment service type from the online marketplace. The partial shipping information is partial because it may not include the weight information of the shipment nor may it specify a specific shipping provider or a specific shipping service within a shipping provider.

The dormant shipping label generator 306 generates a dormant shipping label based on the partial shipping information received in the shipping information module 304. For example, the dormant shipping label generator 306 may generate a unique identifier, such as a series of letters and numbers that is associated with the shipping information received in the shipping information module 304. In one embodiment, the unique identifier may be generated based on the shipping information and may correspond to a shipping identifier scheme from a shipping service provider. In another embodiment, the unique identifier may be a generic identifier provided by an intermediate shipping service provider that is not affiliated with any of the shipping service providers, but integrates with multiple shipping service providers. In one embodiment, the dormant shipping label may include a machine-readable symbol or code generated based on the shipping information.

The dormant shipping label may be inactive and not valid until the required information such as package weight and shipping service has been provided and the shipping payment from the shipper or marketplace seller has been confirmed. In one embodiment, the dormant shipping label identifies a specific shipping service provider. In another embodiment, the dormant shipping label may be provided by an intermediate shipping service provider that integrates with multiple shipping service providers.

The dormant shipping label generator 306 leverages the existing shipping service provider module 308 to provide a dormant shipping label to the shipper to be used with the specific shipping service provider or leverages the intermediate shipping service provider module 310 to provide a dormant shipping label to the shipper to be used with the intermediate shipping service provider that integrates with multiple existing shipping providers to take care of the actual shipment of the package.

In one embodiment, the shipping service provider may activate a dormant shipping label and provide an identification of the shipping service provider, the shipping service (two-day with insurance) and the shipping cost associated with the dormant shipping label to the dormant shipping label application 122. In one embodiment, the dormant shipping label application 122 may request a payment from a financial account of the shipper in the amount of the shipping cost and receive confirmation for such payment.

For example, the dormant shipping label application 122 may allow for the automatic debit from an associated account upon the dormant shipping label activation. In another example, the dormant shipping label application 122 maintains a running balance, and debits from an associated account periodically (e.g., once every ‘n’ days, once every ‘n’ label activations, once the balance exceeds an amount threshold, or any combination). With the option of debiting the payment from the associated account upon the dormant shipping label activation, one can simply take the package or shipment to any package drop-off location operated by the shipping service provider (e.g., post office) where the dormant shipment label is activated at drop off. Payment debit may also be taken care of automatically.

In another embodiment, the request may include the dormant shipping label, an identification of the shipping service provider, and a confirmation of payment of the shipping cost associated with the dormant shipping label. In this embodiment, the shipper takes the shipment to the shipping service provider and pays for the shipping cost at the time of drop off.

### Example Scenario

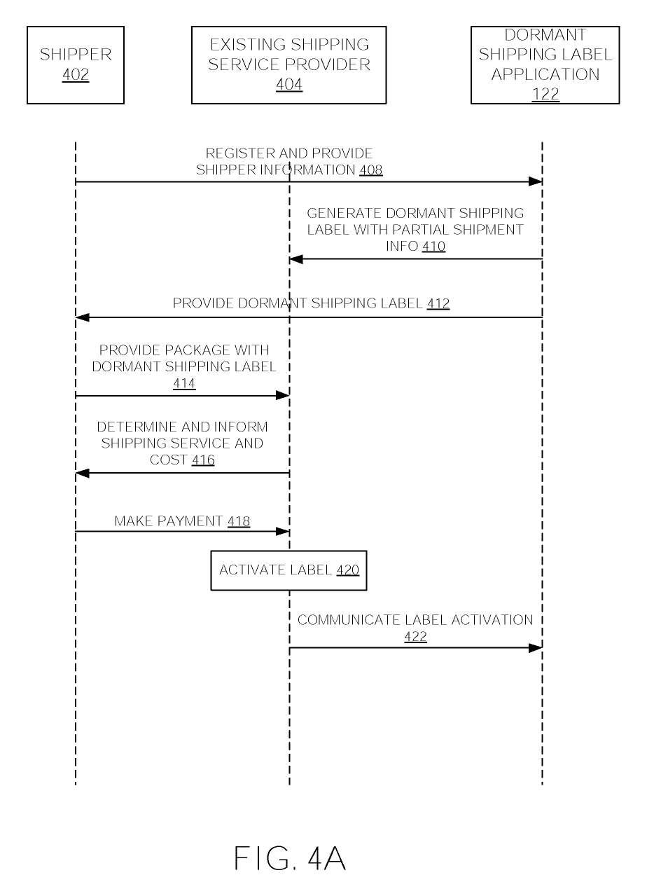

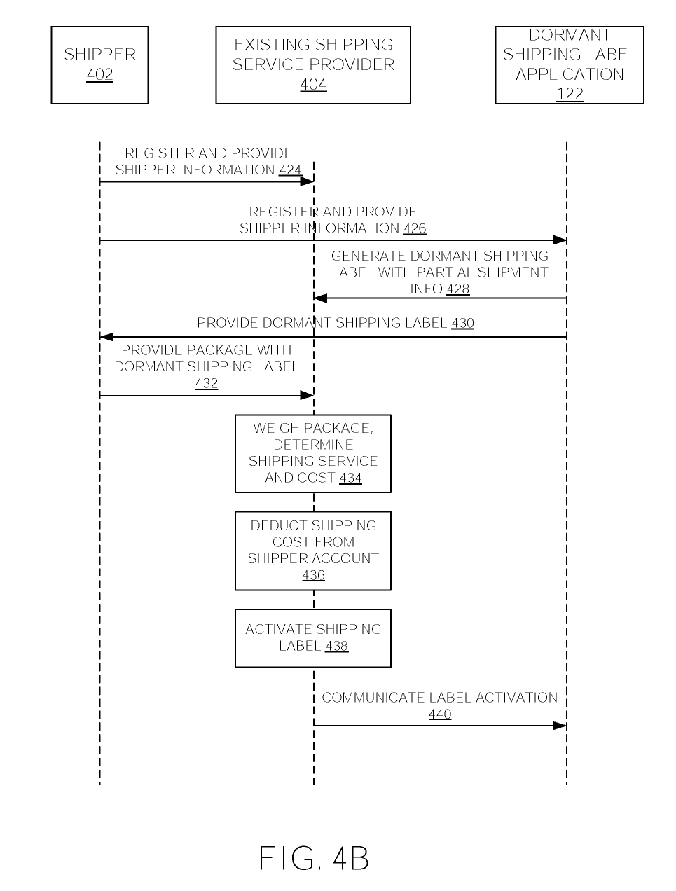

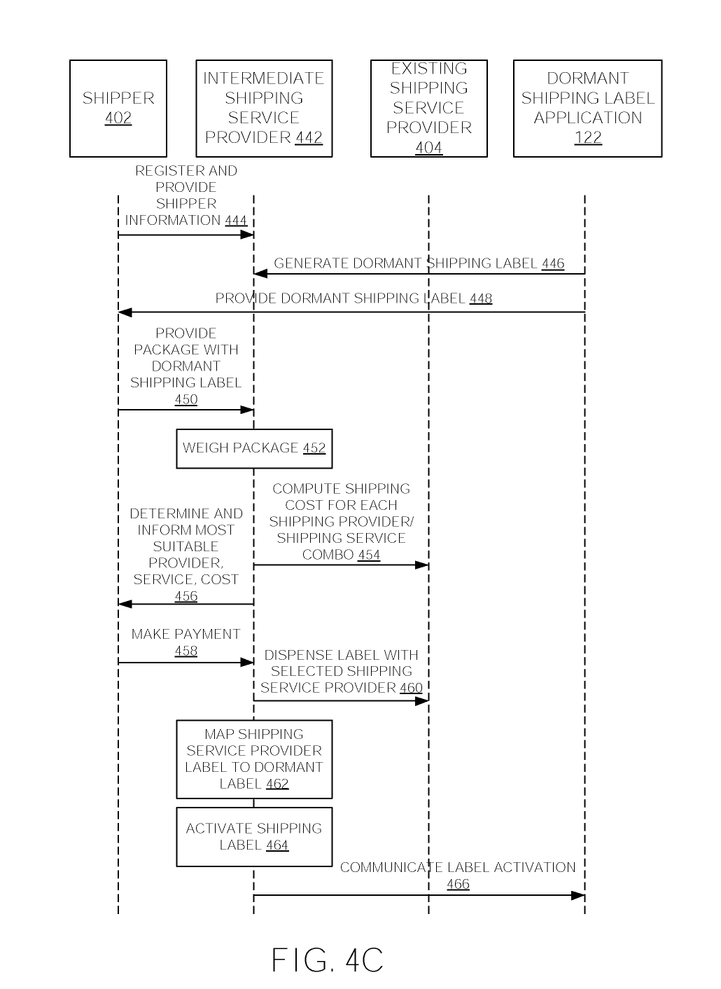

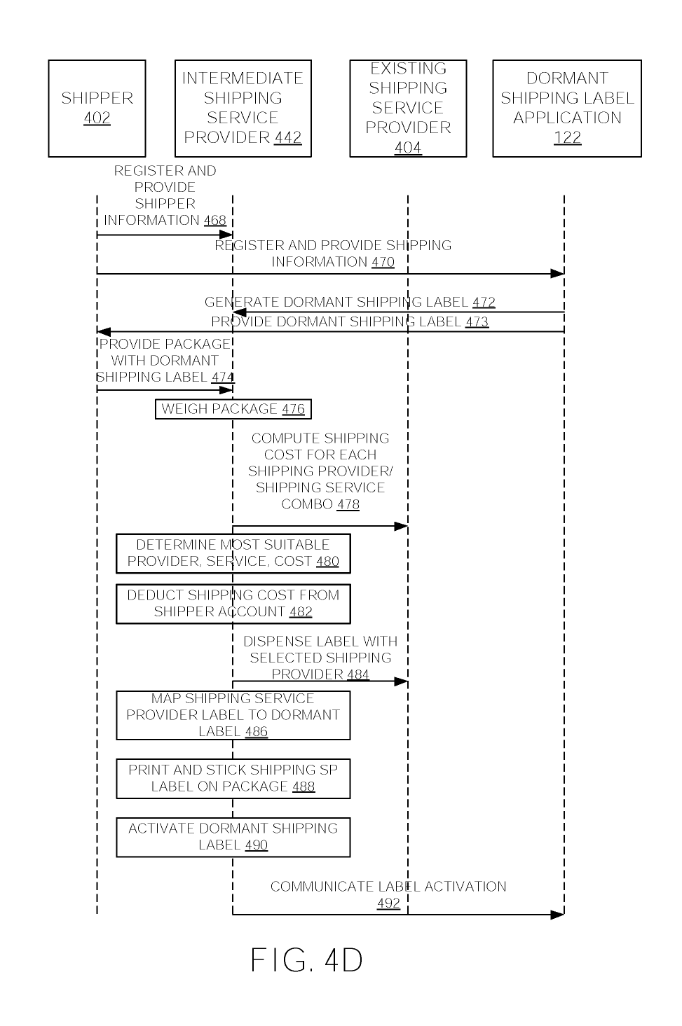

FIGS. 4A and 4B are examples of a dormant shipping label application 122 that integrates with a ‘real’ shipping provider service that supports the concept of dormant shipping label. One purpose is to make it easier for the seller or shipper to print a dormant shipping label with all available information and desired quality of shipment service specification that enable the ‘real’ shipping service provider to weigh the package, determine the appropriate shipping service to meet the desired shipment specification, and activate the dormant shipping label when the shipment is deposited. Payment can be in one of many ways. FIG. 4A illustrates a cash payment at the shipping service provider. FIG. 4B illustrates an account debit from a shipper's financial account.

FIG. 4A is an example of a dormant shipping label system that enables a seller or a shipper 402 to request and obtain a dormant shipping label from a dormant shipping label application 122. The shipper 402 may then affix the dormant shipping label on a shipment box and deliver it to one of the shipping service providers approved by the dormant shipping label application 122.

At operation 408, the shipper 402 may register and provide shipper information with the dormant shipping label application 122. In one embodiment, the shipper 402 may be a registered seller in the marketplace application 120. As such, the dormant shipping label application 122 may extract the shipper's information from the marketplace application 120. For example, the shipper information may include a name, a mailing address, an e-mail address, and financial account information.

At operation 410, the dormant shipping label application 122 may generate a dormant shipping label based on the shipper's information (registration) and the partial shipping information for the existing shipping service provider 404. The partial shipping information may include transaction information from the marketplace application 120, information about the item to be shipped, and/or a destination address. However, the partial shipping information may or may not include a weight of the shipment, nor may it include the shipping provider or shipping service to be used for shipping the package.

At operation 412, the dormant shipping label application 122 provides the dormant shipping label to the shipper 402. The shipper 402 may print the dormant shipping label and affix it to the corresponding package to be shipped.

At operation 414, the shipper 402 may provide the package with the dormant shipping label at a facility operated by or on behalf of the existing shipping service provider 404.

At operation 416, the shipping service provider 404 may weigh the package, determine the most appropriate shipping service to be used for the package based on the weight of the package and the cost of shipping the package, and inform the shipper 402 of the shipping cost.

At operation 418, the shipper 402 pays for the shipping cost at the shipping service provider 404.

At operation 420, the shipping service provider 404 activates the dormant shipping label.

At operation 422, the shipping service provider 404 provides a confirmation that the dormant shipping label has been activated to the dormant shipping label application 122.

FIG. 4B shows a ladder diagram illustrating one example embodiment of a process for generating a dormant shipping label with shipping cost deducted from a shipper's account.

At operation 424, the shipper 402 may register and provide shipper information to an existing shipping service provider 404. At operation 426, the shipper 402 may also register and provide partial shipping information to a dormant shipping label application 122. In one embodiment, the shipper 402 may be a registered seller in the marketplace application 120. As such, the dormant shipping label application 122 may extract the shipper's information from the marketplace application 120. For example, the shipper information may include a name, a mailing address, an e-mail address, and financial account information.

At operation 428, the dormant shipping label application 122 may generate a dormant shipping label based on the shipper's information (registration) and the partial shipping information from the existing shipping service provider 404. The partial shipping information may include transaction information from the marketplace application 120, information about the item to be shipped, and/or a destination address. However, the partial shipping information may or may not include a weight of the shipment, nor may it include the shipping provider or shipping service to be used for shipping the package.

At operation 430, the dormant shipping label application 122 provides the dormant shipping label to the shipper 402. The shipper 402 may print the dormant shipping label and affix it to the corresponding package to be shipped.

At operation 432, the shipper 402 may provide the package with the dormant shipping label at a facility operated by or on behalf of the existing shipping service provider 404.

At operation 434, the existing shipping service provider 404 may weigh the package, determine the most appropriate shipping service to be used for the package based on the weight of the package and the cost of shipping the package, and inform the shipper of the shipping cost.

At operation 436, the existing shipping service provider 404 deducts the shipping cost from the shipper's account based on the information provided in operation 424.

At operation 438, the shipping service provider 404 activates the dormant shipping label.

At operation 440, the shipping service provider 404 provides a confirmation that the dormant shipping label has been activated to the dormant shipping label application 122.

FIGS. 4C and 4D are examples of a dormant shipping label application 122 that integrates with an intermediate shipping provider. The marketplace application 120 may think of this intermediate shipping provider as a real one, use the intermediate shipping provider to print a dormant label providing it with the same qualities of service that are desired of the shipment. In this case, the intermediate shipping provider may run the shipment across multiple ‘real’ shipping providers to determine the best shipping provider/shipping service to be used for the specific shipment. This intermediation can mean that the intermediate shipping provider can even leverage multiple real shipping providers for the single shipment. An example of this would be: the best and most cost effective way to ship a package from California to a specific address in Florida might be to use UPS from California to a UPS service center in Florida and then use USPS for the last leg, to deliver the package to the local Florida address. However, all these would be transparent to the caller, in this example, the marketplace application 122. When a caller wants to track the shipment, the caller will use the dormant label that likely is meaningful only to the intermediate shipping provider to ask for the status. The intermediate shipping provider will look up a map table to determine the real shipping provider and the label dispensed by the real shipping provider and look up the tracking status from the real shipping provider.

FIG. 4C shows a ladder diagram illustrating one example embodiment of a process for generating a dormant shipping label for use at an intermediate shipping service provider with shipping cost paid when the package is dropped off at a facility owned by or operated on behalf of the intermediate shipping service provider.

At operation 444, the shipper 402 may register and provide shipper information with an intermediate shipping service provider 442. In one embodiment, an intermediate shipping service provider 442 may be a shipping service facility not affiliated with any shipping service providers. In one embodiment, the shipper 402 may be a registered seller in the marketplace application 120. As such, the dormant shipping label application 122 may extract the shipper's information from the marketplace application 120. For example, the shipper information may include a name, a mailing address, an e-mail address, and financial account information.

At operation 446, the dormant shipping label application 122 may generate a dormant shipping label based on the shipper's information (registration) and the partial shipping information from the intermediate shipping service provider 442. The partial shipping information may include transaction information from the marketplace application 120, information about the item to be shipped, and/or a destination address. However, the partial shipping information may or may not include a weight of the shipment, nor may it include the shipping provider or shipping service to be used for shipping the package.

At operation 448, the dormant shipping label application 122 provides the dormant shipping label to the shipper 402. The shipper 402 may print the dormant shipping label and affix it to the corresponding package to be shipped.

At operation 450, the shipper 402 may provide the package with the dormant shipping label at a facility operated by or on behalf of the intermediate shipping service provider 442.

At operation 452, the intermediate shipping service provider 442 may weigh the package.

At operation 454, the intermediate shipping service provider 442 may communicate with several shipping service providers to determine their respective shipping cost for shipping a package of a specific weight from the shipper's address to the recipient address.

At operation 456, the third party shipping service provider 442 determines an appropriate shipping service provider and an appropriate shipping service based on the partial shipping information, the shipping cost from each shipping service provider based the weight of the package and informs the shipper 402. In an embodiment, the shipping cost provided by the third party shipping provider may include a mark-up added by the intermediate shipping service provider to the cost provided by the selected shipping serviced provider.

At operation 458, the shipper 402 makes a payment to the intermediate shipping service provider 442.

At operation 460, the intermediate shipping service provider 442 dispenses a shipping label associated with the selected shipping service provider.

At operation 462, the intermediate shipping service provider 442 maintains a mapping of the dormant shipping label to the shipping label associated with the selected shipping service provider.

At operation 464, the intermediate shipping service provider 442 activates the dormant shipping label.

At operation 466, the intermediate shipping service provider 442 provides a confirmation that the dormant shipping label has been activated to the dormant shipping label application 122.

FIG. 4D shows a ladder diagram illustrating one example embodiment of a process for generating a dormant shipping label for use at an intermediate shipping service provider with shipping cost deducted from a shipper's account.

At operation 468, the shipper 402 may register and provide shipper information to an intermediate shipping service provider 442. In one embodiment, an intermediate shipping service provider 442 may be a shipping service facility not affiliated with any shipping service providers. In one embodiment, the shipper 402 may be a registered seller in the marketplace application 120. As such, the dormant shipping label application 122 may extract the shipper's information from the marketplace application 120. For example, the shipper information may include a name, a mailing address, an e-mail address, and financial account information.

At operation 470, the shipper 402 may register and provide shipping information with the dormant shipping label application 122.

At operation 472, the dormant shipping label application 122 may generate a dormant shipping label based on the shipper's information (registration) and the partial shipping information from the intermediate shipping service provider 442. The partial shipping information may include transaction information from the marketplace application 120, information about the item to be shipped, and/or a destination address. However, the partial shipping information may or may not include a weight of the shipment, nor may it include the shipping provider or shipping service to be used for shipping the package.

At operation 473, the dormant shipping label application 122 provides the dormant shipping label to the shipper 402.

At operation 474, the shipper 402 may provide the package with the dormant shipping label at a facility operated by or on behalf of the intermediate shipping service provider 442.

At operation 476, the intermediate shipping service provider 442 may weigh the package.

At operation 478, the intermediate shipping service provider 442 may communicate with several shipping service providers to determine their respective shipping cost.

At operation 480, the intermediate shipping service provider 442 determines an appropriate shipping service provider and an appropriate shipping service based on the partial shipping information, the shipping cost from each shipping service provider based the weight of the package, and informs the shipper. In an embodiment, the shipping cost provided by the intermediate shipping provider 442 may include a mark-up added by the intermediate shipping service provider 442 to the cost provided by the selected shipping serviced provider 404.

At operation 482, the intermediate shipping service provider 442 deduct a shipping cost from an account of the shipper based on the registration information of the shipper.

At operation 484, the intermediate shipping service provider 442 dispenses a shipping label associated with the selected shipping service provider 404.

At operation 486, the intermediate shipping service provider 442 maintains a mapping of the dormant shipping label to the shipping label associated with the selected shipping service provider 404.

At operation 488, the intermediate shipping service provider 442 prints and sticks the shipping provider label to the package.

At operation 490, the intermediate shipping service provider 442 activates the dormant shipping label.

At operation 492, the intermediate shipping service provider 442 provides a confirmation that the dormant shipping label has been activated to the dormant shipping label application 122.

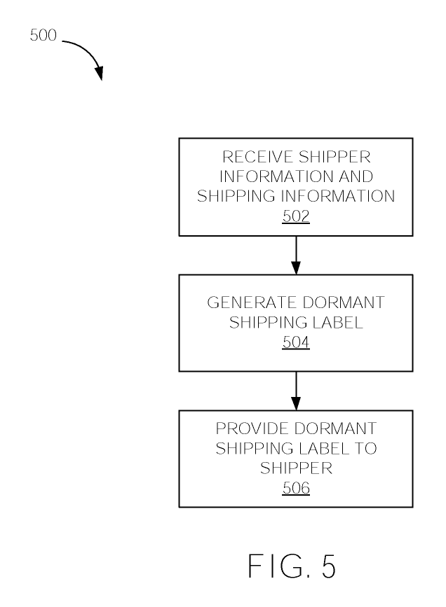

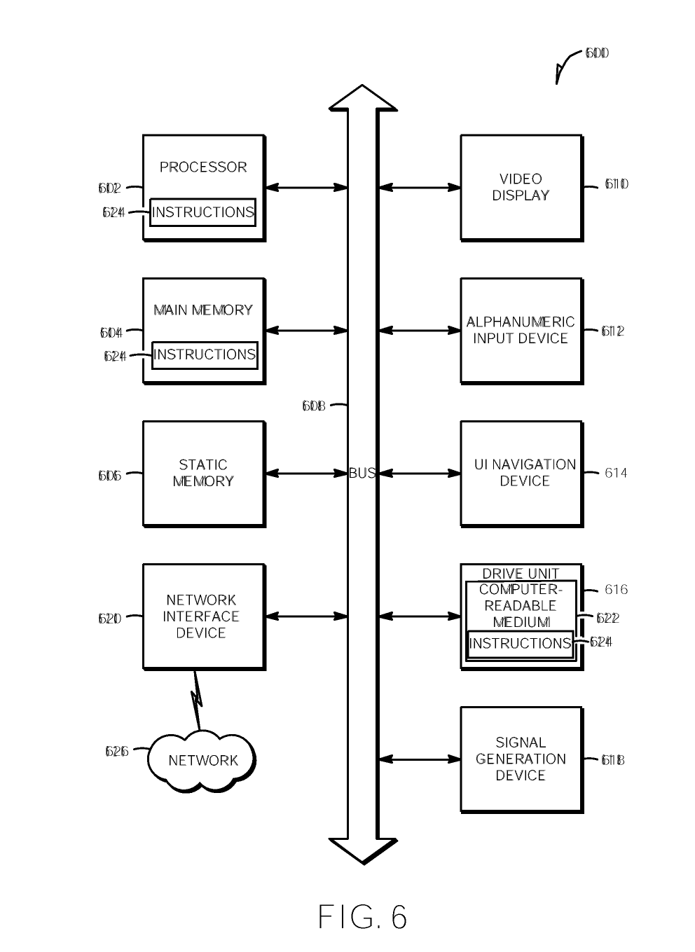

FIG. 5 shows a flow diagram illustrating one example embodiment of a method 500 for generating a dormant shipping label. At operation 502, a shipper registers with the dormant shipping label application 122 and submits shipping information for a shipment. At operation 504, the dormant shipping label application 122 generates a dormant shipping label based on the partial shipping information with either a real shipping service provider or an intermediate shipping service provider. At operation 506, the dormant shipping label provides the dormant shipping label to the shipper. The dormant shipping label to be activated at a facility operated by or on behalf of the shipping service provider that provider the dormant shipment label upon receipt of additional information to compute a shipping cost of the shipment and payment of the shipping cost.

In another example embodiment, the shipper of the package may be the buyer that purchased the item from the seller. The buyer may wish to return the item back to the seller due to a variety of reasons. In such cases where the item is being returned, a dormant return label may be dispensed by the marketplace system and sent across to the buyer for placing on the package. The buyer may be expected to make payment of a certain amount while dropping the package off at a specified shipping service provider. In some cases, the payment for the return shipment may be borne by the seller, based on the seller's return policy. In some cases, the online marketplace may bear the cost of the return shipment.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed, in various example embodiments.

### Example Computer System

FIG. 8 shows a diagrammatic representation of a machine in the example form of a computer system 800 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a UI navigation device 814 (e.g., a mouse), a disk drive unit 816, a signal generation device 818 (e.g., a speaker), and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, with the main memory 804 and the processor 802 also constituting machine-readable media.

The software 824 may further be transmitted or received over a network 826 via the network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A dormant shipping label system comprising:
at least one processor;
a shipper registration module, implemented with the at least one processor, configured to register a user with the dormant shipping label system;
a shipping information module, implemented with the at least one processor, configured to receive partial shipping information for a shipment from the user;
a dormant shipping label generator, implemented with the at least one processor, configured to generate a dormant shipping label based on the partial shipping information without calculation of a shipping cost and provide the dormant shipping label to the user, the dormant shipping label comprising an inactive shipping label before receipt of additional shipping information to compute the shipping cost of the shipment, and receipt of a confirmation of payment of the shipping cost, the dormant shipping label activated and valid with a shipping service provider after receipt of the confirmation of payment of the shipping cost.

2. The dormant shipping label system of claim 1, wherein the shipper registration module is configured to register a financial account of the user, to receive shipping cost information from the shipping service provider, and to debit the shipping cost from the financial account of the user.

3. The dormant shipping label system of claim 1, wherein the shipper registration module is configured communicate with an online marketplace application to access information about the user.

4. The dormant shipping label system of claim 1, wherein the partial shipping information from the user comprises a requested delivery date and a desired shipment service type requested by the user.

5. The dormant shipping label system of claim 1, wherein the dormant shipping label generator further comprises an existing shipping service provider module configured to generate the dormant shipping label associated with the shipping service provider, and to receive a communication from the shipping service provider that the dormant shipping label has been activated.

6. The dormant shipping label system of claim 5, wherein the existing shipping service provider module comprises a shipping service provider interface configured to communicate with a plurality of shipping service providers.

7. The dormant shipping label system of claim 1, wherein the dormant shipping label generator further comprises an intermediate shipping service provider module configured to generate the dormant shipping label, the dormant shipping label not specifying any specific shipping service provider, and to receive a communication from the intermediate shipping service provider that the dormant shipping label has been activated with a first shipping service provider, the dormant shipping label mapped by the intermediate shipping service provider to the first shipping service provider shipping label.

8. The dormant shipping label system of claim 1, wherein the dormant shipping label is activated after a shipping service and the shipping cost are determined using the partial shipping information and the additional shipping information.

9. The dormant shipping label system of claim 8, wherein the additional shipping information comprises the weight of the shipment, the shipping service, and the shipping cost as determined by the shipping service provider.

10. The dormant shipping label system of claim 7, wherein the weight of the shipment, the shipping service, and the shipping cost are determined by an intermediate shipping service provider, the intermediate shipping service provider in communication with a plurality of shipping service providers, the intermediate shipping service provider to determine and select one shipping service provider from the plurality of shipping service providers based on the partial shipping information and the weight of the shipment.

11. A computer-implemented method for a dormant shipping label system comprising:
registering a user with the dormant shipping label system;
receiving partial shipping information for a shipment from the user; and
generating, using a processor of a machine, a dormant shipping label based on the partial shipping information without calculation of a shipping cost and providing the dormant shipping label to the user, the dormant shipping label comprising an inactive and not valid shipping label before receipt of additional shipping information to compute the shipping cost of the shipment, and receipt of a confirmation of payment of the shipping cost, the dormant shipping label activated and valid with a shipping service provider after receipt of the confirmation of payment of the shipping cost.

12. The method of claim 11, further comprising:
registering a financial account of the user;
receiving shipping cost information from the shipping service provider; and
debiting the shipping cost from the financial account of the user.

13. The method of claim 11, further comprising:
communicating with an online marketplace application to access information about the user.

14. The method of claim 11, wherein the partial shipping information from the user comprises a requested delivery date and a desired shipment service type requested by the user.

15. The method of claim 11, further comprising:
communicating with a plurality of shipping service providers;
generating the dormant shipping label associated with the shipping service provider; and
receiving a communication from the shipping service provider that the dormant shipping label has been activated.

16. The method of claim 11, further comprising:
generating the dormant shipping label, the dormant shipping label not specifying any specific shipping service provider; and
receiving a communication from the intermediate shipping service provider that the dormant shipping label has been activated with a first shipping service provider, the dormant shipping label mapped by the intermediate shipping service provider to the first shipping service provider shipping label.

17. The method of claim 11, wherein the dormant shipping label is activated after a shipping service and the shipping cost are determined using the partial shipping information and the additional shipping information.

18. The method of claim 17, wherein the weight of the shipment, the shipping service, and the shipping cost are determined by the shipping service provider.

19. The method of claim 17, wherein the additional shipping information comprises the weight of the shipment, the shipping service, and the shipping cost as determined by an intermediate shipping service provider, the intermediate shipping service provider in communication with a plurality of shipping service providers, the intermediate shipping service provider to determine and select one shipping service provider from the plurality of shipping service providers based on the partial shipping information and the weight of the shipment.

20. A non-transitory computer-readable storage medium storing a set of instructions that, when executed by a processor, cause the processor to perform operations, comprising:
registering a user with the dormant shipping label system;
receiving partial shipping information for a shipment from the user; and
generating a dormant shipping label based on the partial shipping information and providing the dormant shipping label to the user, the dormant shipping label to be activated with a shipping service provider upon receipt of additional shipping information to compute a shipping cost of the shipment, and upon receipt of payment of the shipping cost.
